(19) United States
(12) Patent Application Publication
(10) Pub. No.: US 2015/0028719 A1
(43) Pub. Date: Jan. 29, 2015

(54) SLIP RING SYSTEM

(71) Applicant: TOYOTA JIDOSHA KABUSHIKI KAISHA, Toyota-shi, Aichi-ken (JP)

(72) Inventors: Daisuke Tokozakura, Susono-shi (JP); Kazuya Arakawa, Fujinomiya-shi (JP); Yuya Takahashi, Susono-shi (JP); Keisuke Ichige, Nagoya-shi (JP)

(73) Assignee: TOYOTA JIDOSHA KABUSHIKI KAISHA, Toyota-shi, Aichi-ken (JP)

(21) Appl. No.: 14/381,319

(22) PCT Filed: Feb. 27, 2013
(86) PCT No.: PCT/IB2013/000484

§ 371 Date: Aug. 27, 2014

(30) Foreign Application Priority Data
Mar. 2, 2012 (JP) 2012-046576

(51) Int. Cl. H02K 9/28; H02K 13/00

(52) U.S. Cl. CPC H02K 9/28; H02K 13/003
USPC 310/227

(57) ABSTRACT

In a slip ring system (20) that includes: a slip ring (21) that is provided on a first rotating shaft (12) rotating about an axis (Ax); and a brush (22) that is provided in a case (11) and is pressed against the slip ring (21) and that transfers electricity between the slip ring (21) and the brush (22), a housing room (29) that is provided in the case (11) and houses the slip ring (21) and the brush (22) is provided, and a fluorinated liquid (FL) is filled in the housing room (29).

### BACKGROUND OF THE INVENTION

1. Field of the Invention

The present invention relates to a slip ring system in which a ring member is provided on one of a rotating body and a stationary unit, in which a brush member is provided on the other, and in which the brush member is pressed against the ring member and transfer electricity therebetween.

2. Description of Related Art

A slip ring system has been known in which a slip ring is provided on one of a rotating body and a stationary unit, in which a brush is provided on the other, and in which the brush is pressed against the slip ring to transfer electricity such as electric power or an electric signal therebetween. As such a slip ring system, a system has been known in which a slip ring and a brush are housed in a cover member that is provided with plural vent holes for heat radiation on a peripheral wall thereof (See Japanese Patent Application Publication No. 2011-166942 (JP 2011-166942 A)). In addition, as prior art documents that are related to the present invention, there exist Japanese Patent Application Publication No. 2011-200038 (JP 2011-200038 A), Japanese Patent Application Publication No. 06-104355 (JP 06-104355 A), Japanese Patent Application Publication No. 10-143791 (JP 10-143791 A), Japanese Patent Application Publication No. 03-119580 (JP 03-119580 A), and Japanese Patent Application Publication No. 07-249281 (JP 07-249281 A).

Although the slip ring and the brush are cooled by air in the system disclosed in JP 2011-166942 A, cooling efficiency by air cooling is low. Also, because abrasive dusts that are produced by slide between the slip ring and the brush may be dispersed within the cover member in this system, there is a possible need for a mechanism to collect the abrasive dusts.

### SUMMARY OF THE INVENTION

The present invention provides a slip ring system that can restrict dispersion of abrasive dusts and that can improve cooling efficiencies of a slip ring and a brush.

The slip ring system according to one aspect of the present invention includes a ring member, a brush member, and a housing room. The ring member has conductivity. The ring member is provided on one of a rotating body and a stationary unit. The rotating body rotates about an axis. The stationary unit is fixed in a non-rotatable manner. The brush member has conductivity. The brush member is provided on the other of the rotating body and the stationary unit. The brush member is pressed against the ring member. The slip ring system transfers electricity between the ring member and the brush member. The housing room is provided in the stationary unit. The housing room houses the ring member and the brush member therein. A fluorinated liquid is filled in the housing room.

According to the slip ring system of the aspect of the present invention, because the ring member and the brush member are housed in the housing room, it is possible to prevent a foreign substance or moisture from entering. Accordingly, it is possible to prevent spark discharge that can be caused by the above. In addition, according to the aspect of the present invention, because the fluorinated liquid is filled in the housing room, the ring member and the brush member can be cooled by the fluorinated liquid. The fluorinated liquid exhibits superior heat transfer, performance to the air due to its higher thermal conductivity, greater specific heat capacity, and higher density. Therefore, it is possible to improve cooling efficiencies of the ring member and the brush member when compared to air cooling. Furthermore, by promoting cooling of the ring member and the brush member, it is possible to restrict wear of these members, and it is also possible to restrict an amount of electricity flowed therebetween from decreasing. The fluorinated liquid exhibits an inferior boundary lubricating property to mineral oils. Accordingly, even when the fluorinated liquid flows into a contacting portion between the ring member and the brush member, the contacting portion remains in a boundary lubrication state or a dry friction state. Therefore, it is possible to maintain electrical continuity between the ring member and the brush member while cooling these. Moreover, according to the aspect of the present invention, it is possible with the fluorinated liquid to eliminate the abrasive dusts from the contacting portion between the ring member and the brush member. Then, the fluorinated liquid can collect abrasive dusts. Therefore, it is possible to restrict dispersion of the abrasive dusts.

In the above slip ring system, the fluorinated liquid may be filled in the housing room such that a headspace is provided in the housing room. In this case, a portion of the ring member can be exposed in the headspace by adjusting an amount of the fluorinated liquid that is filled in the housing room. As it has been known, churning loss and drag loss occur when an object rotates in a liquid. In this configuration, because a portion of the ring member is exposed to the outside of the fluorinated liquid, it is possible to reduce degrees of the churning loss and the drag loss.

In the above slip ring system, the fluorinated liquid may be filled in the housing room such that a surface thereof is positioned higher than the bottom end of the ring member and lower than the top end of the ring member when the rotating body stops. In this case, it is possible to securely expose a portion of the ring member to the outside of the fluorinated liquid. Accordingly, it is possible to reduce the degrees of the churning loss and the drag loss.

In the above slip ring system, the plural brush members may be provided on the slip ring, and the fluorinated liquid may be filled in the housing room such that a contacting portion between at least one of the brush members and the ring member is soaked in the fluorinated liquid when the rotating body stops. According to this configuration, the contacting portion between at least one of the brush members and the ring member can be soaked in the fluorinated liquid when the rotating body stops. Therefore, it is possible to promptly cool this contacting portion.

In the above slip ring system, the ring member may be provided on the rotating body, the three brush members may be provided in the stationary unit, the three brush members may be disposed at 120° intervals on an outer periphery of the ring member in a circumferential direction such that any two of the three brush members are positioned lower than the other brush member, and the fluorinated liquid may be filled in the housing room such that contacting portions between the ring member and the two brush members of the three brush members that are positioned lower than the other brush member are soaked in the fluorinated liquid when the rotating body stops. According to this configuration, the contacting portions between the ring member and the two brush members that are provided on the lower side can be soaked in the fluorinated liquid when the rotating body stops. Therefore, it is possible to promptly cool these contacting portions.

The above slip ring system may include a case member and a plate member. The case member may be fixed to the stationary unit. The housing room may be formed in the case member. The ring member or the brush member, which is provided in the stationary unit, may be attached to the plate member. The plate member may be fixed to the case member in a non-rotatable manner. The plate member may be fixed to extend in a direction that intersects with the axis. The plate member may be provided with a communication hole that penetrates through the plate member in a direction that the axis extends. According to this configuration, it is possible by the plate member to securely fix the brush member to the case member. In addition, according to this aspect, the fluorinated liquid can be moved freely in an axial direction. Accordingly, it is possible to generate flow of the fluorinated liquid in the axial direction in the housing room. Because this increases flow speed of the fluorinated liquid, it is possible to increase a heat transfer coefficient between the fluorinated liquid and a combination of the ring member and the brush member and a heat transfer coefficient between the fluorinated liquid and the case member. Therefore, it is possible to further improve the cooling efficiencies of the ring member and the brush member.

In this configuration, the brush member may be attached to the plate member, and the communication hole may be provided in the plate member to align with the brush member in the circumferential direction. In this case, the flow of the fluorinated liquid can be generated around the brush member. Therefore, it is possible to further improve the cooling efficiencies of the ring member and the brush member.

As it has been described so far, according to the slip ring system of the present invention, the cooling efficiencies of the ring member and the brush member can be improved because the ring member and the brush member are housed in the housing room and also because the fluorinated liquid is filled in the housing room. In addition, the fluorinated liquid can collect the abrasive dusts that are produced by the ring member or the brush member. Therefore, it is possible to restrict the dispersion of the abrasive dusts.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that schematically shows a hybrid motor in which a slip ring system according to a first embodiment of the present invention is installed;

FIG. 2 is a view that schematically shows an interior of the slip ring system;

FIG. 3 is a view of a stationary plate that is seen from the right in FIG. 2;

FIG. 4 is a view of a stationary plate in a slip ring system according to a second embodiment of the present invention that is seen from the right in FIG. 5;

FIG. 5 is a view that schematically shows an interior of the slip ring system according to the second embodiment;

FIG. 6 is a view of a stationary plate in a slip ring system according to a third embodiment of the present invention that is seen from the right in FIG. 7; and

FIG. 7 is a view that schematically shows an interior of the slip ring system according to the third embodiment.

### DETAILED DESCRIPTION OF EMBODIMENTS

### First Embodiment

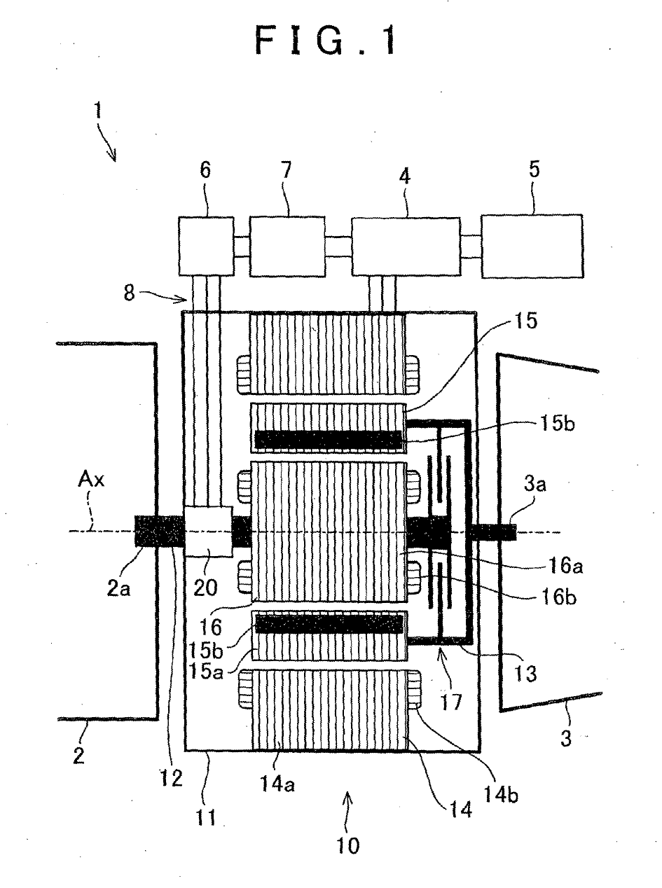

A description will be made on a slip ring system according to the present invention with reference to FIG. 1 to FIG. 3. FIG. 1 schematically shows a hybrid motor 10 in which a slip ring system according to a first embodiment of the present invention is installed. This hybrid motor 10 is mounted in a vehicle 1. The vehicle 1 includes an internal combustion engine 2 and a transmission 3. The internal combustion engine 2 is a known diesel engine that is mounted in a vehicle and so on. The transmission 3 is also mounted in a vehicle and is a known transmission that is configured to be able to change a gear ratio between an input shaft 3a and an output shaft (not shown). Thus, detailed descriptions of these will not be made. The hybrid motor 10 is provided between the internal combustion engine 2 and the transmission 3 to constitute a part of a power transmission passage between the internal combustion engine 2 and the transmission 3.

As shown in this drawing, the hybrid motor 10 includes a case 11, a first rotating shaft 12, and a second rotating shaft 13 that is in a hollow cylindrical shape. The first rotating shaft 12 and the second rotating shaft 13 are provided to be rotatable about an axis Ax. The first rotating shaft 12 is coaxially provided on the inner side of the second rotating shaft 13. The first rotating shaft 12 is connected to an output shaft 2a of the internal combustion engine 2 so that the first rotating shaft 12 and the output shaft 2a rotate together. The second rotating shaft 13 is connected to the input shaft 3a of the transmission 3 so that the second rotating shaft 13 and the input shaft 3a rotate together.

The hybrid motor 10 also includes a cylindrical stator 14, a magnetic rotor 15, and a winding rotor 16. The stator 14 is fixed to the case 11 in a non-rotatable manner. The magnetic rotor 15 is provided on the inner side of the stator 14 so that a predetermined clearance is between the magnetic rotor 15 and the stator 14. The magnetic rotor 15 is supported by the case 11 so as to be rotatable about the axis Ax. Thus, the magnetic rotor 15 is provided to be capable of relative rotation with respect to the stator 14. The second rotating shaft 13 is connected to the magnetic rotor 15 so that the second rotating shaft 13 and the magnetic rotor 15 rotate together. The magnetic rotor 15 is in a cylindrical shape and is formed with a space in an inner periphery thereof. The winding rotor 16 is provided in the space on the inner periphery of the magnetic rotor 15 so that a predetermined clearance is between the winding rotor 16 and the magnetic rotor 15. The winding rotor 16 is attached to the first rotating shaft 12 so that the winding rotor 16 and the first rotating shaft 12 rotate together. Thus, the winding rotor 16 is provided to be capable of relative rotation with respect to the stator 14 and the magnetic rotor 15. The stator 14, the magnetic rotor 15, and the winding rotor 16 are coaxially disposed. That is, when seen in a direction of the axis Ax, in order from the outside, the stator 14, the magnetic rotor 15, and the winding rotor 16 are disposed concentrically.

The stator 14 includes a stator core 14a and plural stator coils 14b. The stator 14 produces a rotating magnetic field in which these plural stator coils 14b are applied with electric current in a predetermined order and thus rotate in the circumferential direction. The magnetic rotor 15 includes a rotor core 15a and plural permanent magnets 15b. The plural permanent magnets 15b are provided in the rotor core 15a to align at predetermined intervals in the circumferential direction. The winding rotor 16 includes a rotor core 16a and plural rotor coils 16b. The winding rotor 16 produces a rotating magnetic field in which these plural rotor coils 16b are applied with the electric current in a predetermined order and thus rotate in the circumferential direction.

The hybrid motor 10 is provided with a clutch 17. The clutch 17 is configured to be switchable between an engaging state where the first rotating shaft 12 and the second rotating shaft 13 rotate together and a disengaging state where the first rotating shaft 12 and the second rotating shaft 13 rotate separately from each other. Because a known hydraulic clutch is used for this clutch 17, for example, a detailed description thereof will not be made.

As shown in the drawing, the stator 14 is electrically connected to a battery 5 through an inverter 4. In addition, the winding rotor 16 is electrically connected to the inverter 4 through a rectifier 6 and a booster converter 7. As described above, the winding rotor 16 is provided in a rotatable manner. Thus, the hybrid motor 10 is provided with a slip ring system 20 so that the winding rotor 16 is electrically connected to the rectifier 6.

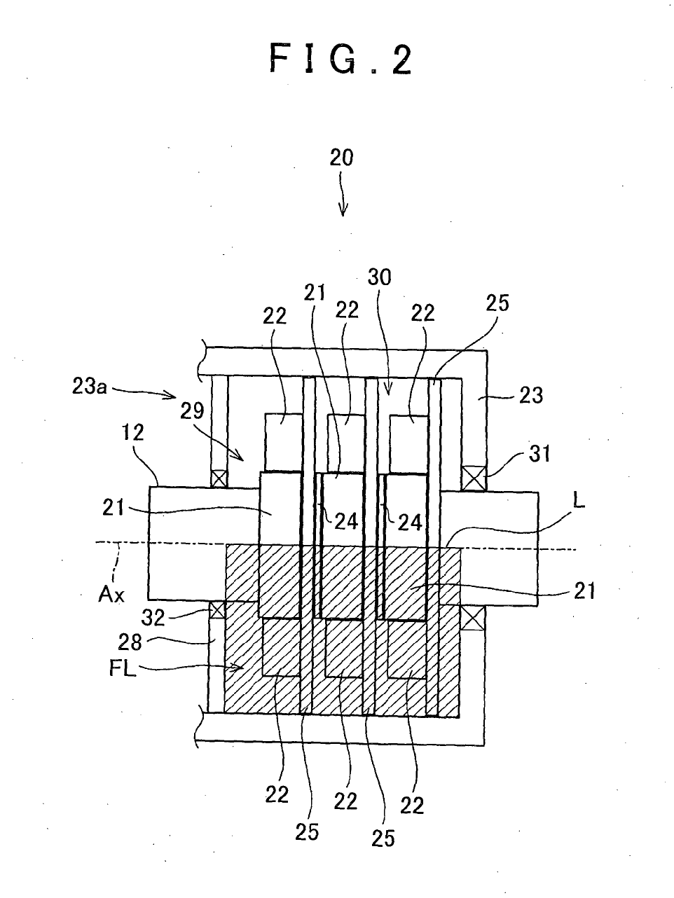

FIG. 2 schematically shows an interior of the slip ring system 20. The slip ring system 20 includes plural (three in FIG. 2) slip rings 21 as ring members, plural brushes 22 as brush members, and .a housing case 23 as a case member that houses the slip rings 21 and the brushes 22 therein. Each of the slip ring 21 and the brush 22 is constructed from a conductive material. The slip ring 21 is formed in a ring shape. The slip ring 21 is fixed to the first rotating shaft 12 so that the slip ring 21 and the first rotating shaft 12 rotate together. Thus, the first rotating shaft 12 can be regarded as a rotating body of the present invention. Although not shown, a conductive connection member is provided in the first rotating shaft 12. One end of the connection member is electrically connected to the slip ring 21, while the other end thereof is electrically connected to the rotor coil 16b. Accordingly, the slip ring 21 and the rotor coil 16b are electrically connected to each other. An insulating member 24 is provided between the adjacent slip rings 21 to insulate between these slip rings 21.

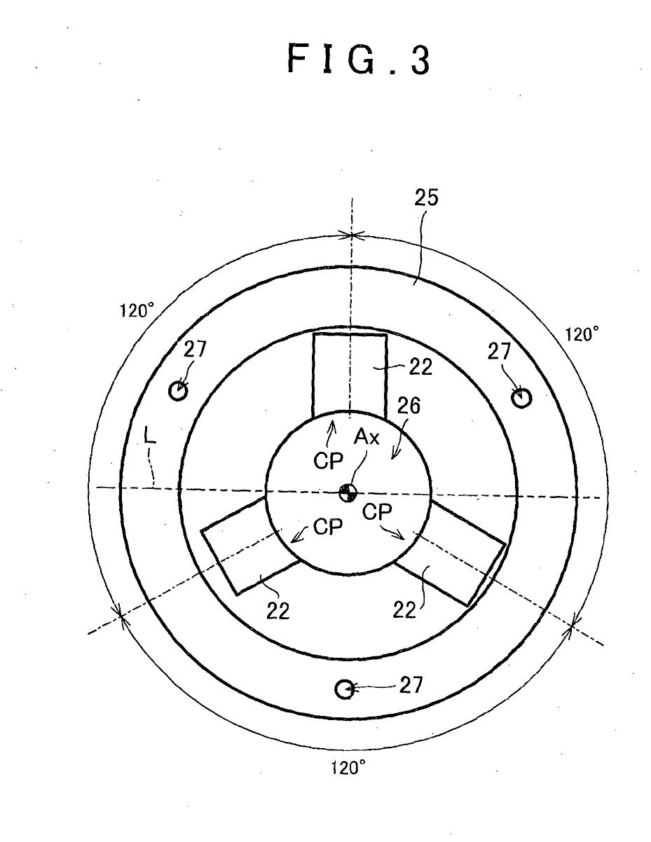

The three brushes 22 are provided for each one of the slip rings 21. That is, the nine brushes 22 are provided in this slip ring system 20. These nine brushes 22 are electrically connected to the rectifier 6 by a cable 8 (see FIG. 1). The brush 22 is supported by a stationary plate 25 as a plate member. The stationary plate 25 supports the brush 22 to restrict movement thereof in the circumferential direction and to allow movement thereof in a radial direction. The stationary plate 25 is fixed to the housing case 23 by a bolt (not shown) in a non-rotatable manner. FIG. 3 is a view in which the stationary plate 25 is seen from the right in FIG. 2. As shown in this drawing, the stationary plate 25 is formed in a disk shape. A shaft hole 26 through which the first rotating shaft 12 passes is provided at the center of the stationary shaft 25. As shown in this drawing, the three brushes 22 are supported by the stationary plate 25 to be disposed at 120° intervals on an outer periphery of the slip ring 21. The stationary plate 25 is provided with a spring (not shown) that urges the brush 22 inward in the radial direction. Accordingly, the brush 22 is pressed against an outer peripheral surface of the slip ring 21. The stationary plate 25 is provided with a bolt hole 27 into which a bolt is inserted. As shown in FIG. 2, each of the stationary plates 25 is fixed in the housing case 23 to extend in a direction that intersects with the axis Ax. In addition, as shown in FIG. 3, each of the stationary plates 25 is fixed in the housing case 23 such that one of the brushes 22 is positioned higher than the other two brushes 22 and that the lower two brushes 22 are aligned in a horizontal direction. The housing case 23 is fixed to the case 11. Therefore, the case 11 corresponds to a stationary side (a stationary unit of the present invention).

The housing case 23 is provided with an opening 23a. The slip ring 21 and the brush 22 are inserted in the housing case 23 through this opening 23a. This opening 23a is closed by a cover member 28. Accordingly, a housing room 29 of a sealed structure is formed in the housing case 23. In addition, the housing room 29 is filled with a fluorinated liquid FL. As the fluorinated liquid FL, a solvent whose boiling point is at a maximum working temperature of the slip ring 21, for example, 150° C. or higher is used. Such a fluorinated liquid is commercially available for a cooling, cleaning, or lubricating purpose. Such a fluorinated liquid can be used in the present invention. For example, Fluorinert® FC-43 made by 3M or such may be used. Therefore, a detailed description of the fluorinated liquid will not be made.

An amount of the fluorinated liquid FL to be filled is adjusted such that a surface thereof is at a level shown by a line L in FIG. 2 and FIG. 3 when the first rotating shaft 12 stops. That is, as shown in FIG. 3, the fluorinated liquid FL is filled in the housing room 29 such that contacting portions CP between the slip ring 21 and the lower two brushes 22 of the three brushes 22 provided on the stationary plate 25 are soaked in the fluorinated liquid FL when the first rotating shaft 12 stops. Accordingly, a headspace 30 is provided in the housing room 29 by filling the fluorinated liquid FL as described above.

The housing case 23 is provided with an oil seal 31 that restricts leakage of the fluorinated liquid FL from a clearance between the housing case 23 and the first rotating shaft 12. The cover member 28 is also provided with an oil seal 32 that restricts leakage of the fluorinated liquid FL from a clearance between the cover member 28 and the first rotating shaft 12.

In this slip ring system 20, when the first rotating shaft 12 rotates, the fluorinated liquid FL is churned and dispersed by the slip ring 21 and the first rotating shaft 12. Accordingly, the one of the three brushes 22 that is positioned higher than the other two brushes 22 is splashed with the fluorinated liquid FL. Therefore, all of the brushes 22 contact the fluorinated liquid FL during rotation of the first rotating shaft 12. In addition, the upper half of each of the slip rings 21 is also splashed with the fluorinated liquid FL due to churning of the fluorinated liquid FL.

The fluorinated liquid FL exhibits a high insulating property. Thus, it is possible to prevent occurrence of a short circuit by filling in the housing room 29. In addition, the fluorinated liquid FL exhibits an inferior boundary lubricating property to mineral oils. Accordingly, even when the fluorinated liquid FL flows into a contacting portion between the slip ring 21 and the brush 22, the contacting portion remains in a boundary lubrication state or a dry friction state. Therefore, contact between the slip ring 21 and the brush 22 is maintained, and thus electrical continuity therebetween is also maintained.

As it has been described so far, according to the slip ring system 20 of the present invention, because the slip ring 21 and the brush 22 are housed in the housing room 29, it is possible to prevent a foreign substance or moisture from entering. Accordingly, it is possible to prevent spark discharge that can be caused by the above. Also, in the present invention, the fluorinated liquid FL is filled in the housing room 29, and each of the slip rings 21 and each of the brushes 22 come into contact with the fluorinated liquid FL during the rotation of the first rotating shaft 12. As described above, because the fluorinated liquid FL exhibits the inferior boundary lubricating property to mineral oils, a liquid film is not formed between the slip ring 21 and the brush 22. Therefore, it is possible to secure a sufficient contact area between the slip ring 21 and the brush 22.

The fluorinated liquid FL exhibits superior heat transfer performance to the air due to its higher thermal conductivity, greater specific heat capacity, and higher density. Therefore, it is possible to improve cooling efficiencies of the slip ring 21 and the brush 22 when compared to air cooling. Degrees of wear of the slip ring 21 and the brush 22 increase with temperature. As it has generally been known, as the temperatures of the slip ring 21 and the brush 22 rise, an amount of electrical flow therebetween decreases. According to the present invention, because the cooling efficiencies of the slip ring 21 and the brush 22 are improved, it is possible to restrict wear of these. Also, it is possible to restrict a decrease in the amount of electrical flow therebetween.

According to the present invention, because the fluorinated liquid FL is filled in the housing room 29, the fluorinated liquid FL can collect abrasive dusts that are produced by the slip rings 21 and the brush 22. Because the abrasive dusts have a higher density than the fluorinated liquid FL, they are deposited at the bottom of the housing room 29. This prevents the dispersion of the abrasive dusts caused by the rotation of the first rotating shaft 12, and thus it is possible to restrict the occurrence of spark discharge, which may be caused by the abrasive dusts.

The fluorinated liquid FL is filled such that the surface thereof is at the level shown by the line L in FIG. 2 and FIG. 3 when the first rotating shaft 12 stops. Because the first rotating shaft 12 churns the fluorinated liquid FL during the rotation of the first rotating shaft 12, churning loss occurs. In addition, drag loss occurs between the surface of the first rotating shaft 12 and the fluorinated liquid FL. In the first embodiment, because the upper halves of the first rotating shaft 12 and the slip ring 21 are exposed in the headspace 30, degrees of the churning loss and the drag loss can be decreased.

Because the amount of the fluorinated liquid FL that is filled in the housing room 29 is adjusted as described above, the contacting portions CP between the lower two brushes 22 and the slip ring 21 can be soaked in the fluorinated liquid FL when the first rotating shaft 12 stops. Accordingly, the contacting portions CP can be cooled promptly when the first rotating shaft 12 stops.

It should be noted that the amount of the fluorinated liquid FL that is filled in the housing room 29 is not limited to the above amount. For example, the housing room 29 can be filled with the fluorinated liquid FL such that the headspace 30 is not formed. In this case, because the slip rings 21 and the brushes 22 are soaked in the fluorinated liquid FL, the cooling efficiencies thereof can further be improved.

The fluorinated liquid FL may be filled in the housing room 29 such that the surface thereof is positioned higher than the bottom end of the slip ring 21 and lower than the top end of the slip ring 21 when the first rotating shaft 12 stops. In this case, because a portion of the slip ring 21 is soaked in the fluorinated liquid FL, the slip ring 21 and the brush 22 can be splashed with the fluorinated liquid FL when the fluorinated liquid FL is churned during the rotation of the first rotating shaft 12. In this case, because the first rotating shaft 12 and the slip ring 21 are partially exposed in the headspace 30, the degrees of the churning loss and the drag loss can also be decreased.

Furthermore, the fluorinated liquid FL may be filled in the housing room 29 such that at least the contacting portion CP between at least one brush 22 of the three brushes 22 and the slip ring 21 is soaked in the fluorinated liquid FL when the first rotating shaft 12 stops. In this case, at least the one contacting portion CP can be cooled promptly when the first rotating shaft 12 stops.

### Second Embodiment

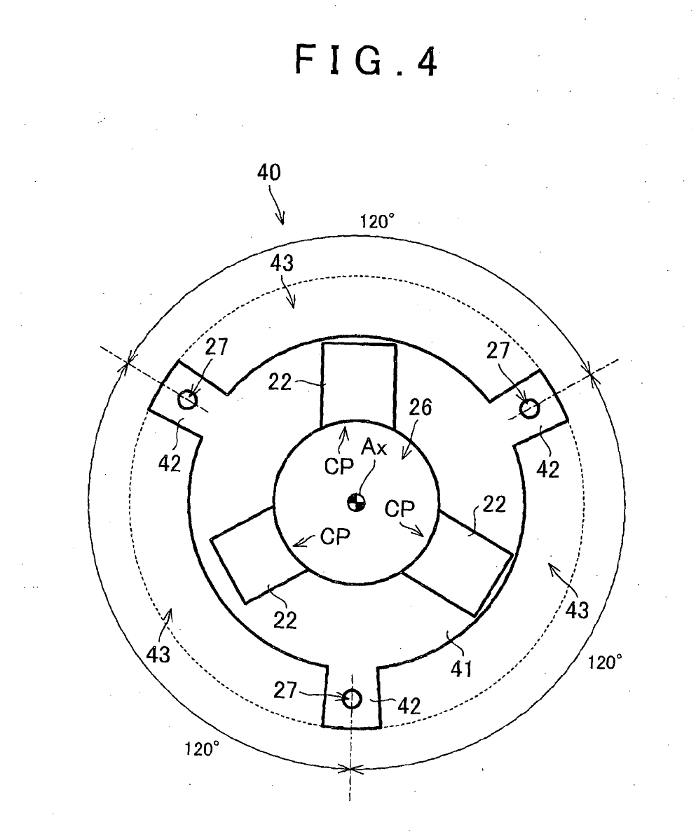

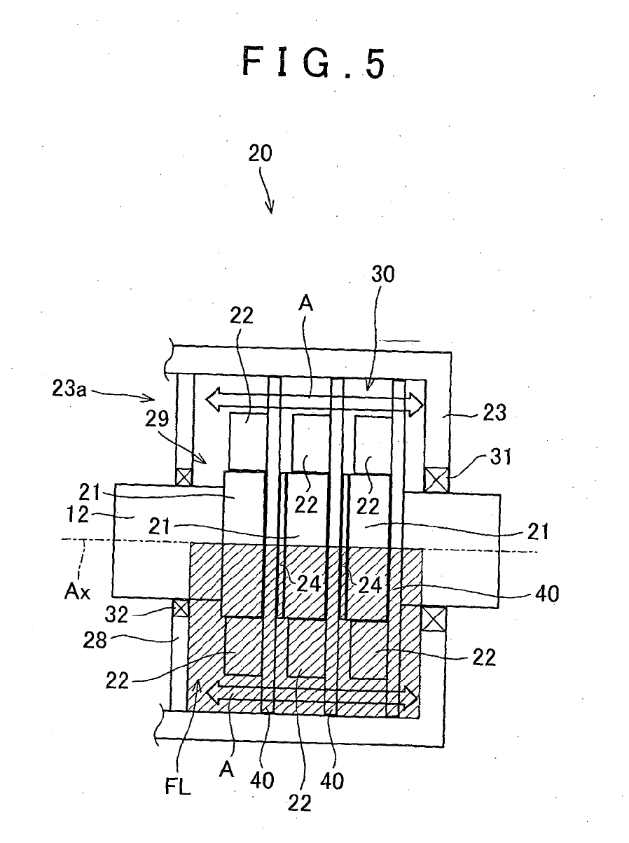

A description will hereinafter be made on the slip ring system according to a second embodiment of the present invention with reference to FIG. 4 and FIG. 5. FIG. 4 corresponds to FIG. 3 of the first embodiment, and it is a drawing in which a stationary plate of this embodiment is seen from the right in FIG. 5. FIG. 5 corresponds to FIG. 2 of the first embodiment. As it is apparent from these drawings, only the shape of the stationary plate of this embodiment differs from the first embodiment, and the rest is the same as the first embodiment. Therefore, in this embodiment, components that are common with the first embodiment are designated by the same reference numerals, and their description is not repeated.

As shown in FIG. 4, a stationary plate 40 of this embodiment includes a base section 41 that supports the brush 22 and three projecting sections 42 that project from the base section 41 to the outer side in the radial direction. The outside diameter of the base 41 is smaller than the inside diameter of the housing room 29. The three projecting sections 42 are provided at 120° intervals. Each of the projecting sections 42 is provided with a bolt hole 27. As described above, the stationary plate 40 has a shape that a portion thereof positioned on the outer side of the brush 22 in the radial direction is eliminated except for portions around the bolt hole 27. Accordingly, the stationary plate 40 is provided with a communication section 43 as a communication hole that penetrates in the direction of the axis Ax.

According to this embodiment, because the communication section 43 is provided in the stationary plate 40, it is possible to generate flow of the fluorinated liquid FL in the direction of the axis Ax, which is indicated by an arrow A in FIG. 5, in the housing room 29. The flow speed of the fluorinated liquid FL can be increased by generating the flow as described above. A heat transfer coefficient of a liquid is proportional to flow speed, and thus the heat transfer coefficient increases with the increased flow speed. Therefore, it is possible by generating the flow of the fluorinated liquid FL, which is indicated by the arrow A, to increase the heat transfer coefficient between the fluorinated liquid FL and a combination of the slip ring 21 and the brush 22 and the heat transfer coefficient between the fluorinated liquid FL and the housing case 23. Accordingly, it is possible to further improve the cooling efficiencies of the slip ring 21 and the brush 22. Therefore, wear of the brush 22 can be restricted because the slip ring 21 and the brush 22 can be restricted from generating heat.

In addition, the abrasive dusts can be removed from a space between the slip ring 21 and the brush 22 by generating the flow of the fluorinated liquid FL as described above. Therefore, it is possible to restrict accumulation of the abrasive dusts in the space between the slip ring 21 and the brush 22. Also, in this embodiment, because the communication section 43 is provided in the stationary plate 40, it is possible to reduce the weight of the stationary plate 40.

The shape of the communication section 43 is not limited to that shown in FIG. 4. For example, plural through holes that penetrate in the direction of the axis Ax may be provided in a portion where the communication section 43 is provided in FIG. 4. Also, in this case, the flow of the fluorinated liquid FL, which is indicated by the arrow A in FIG. 5, can be generated.

### Third Embodiment

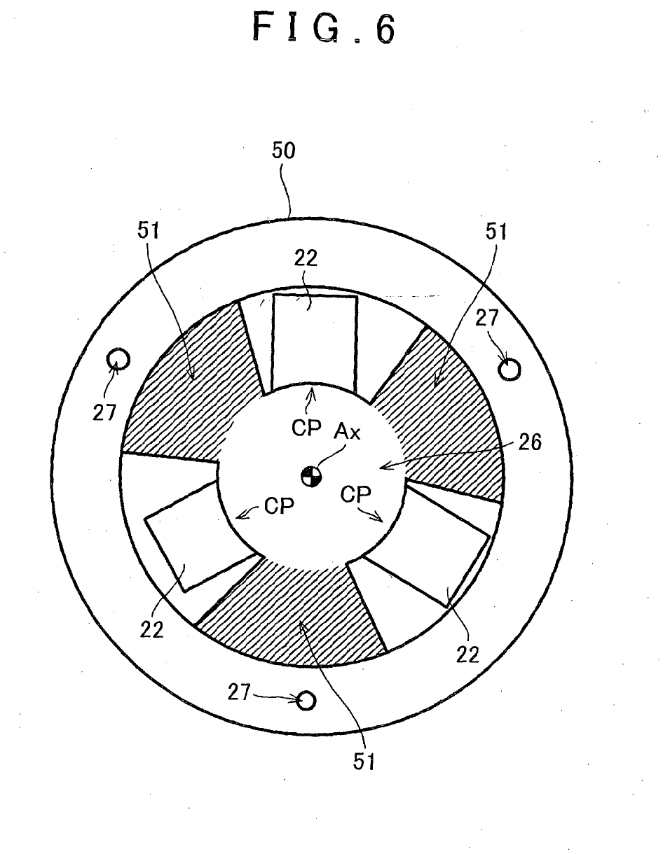

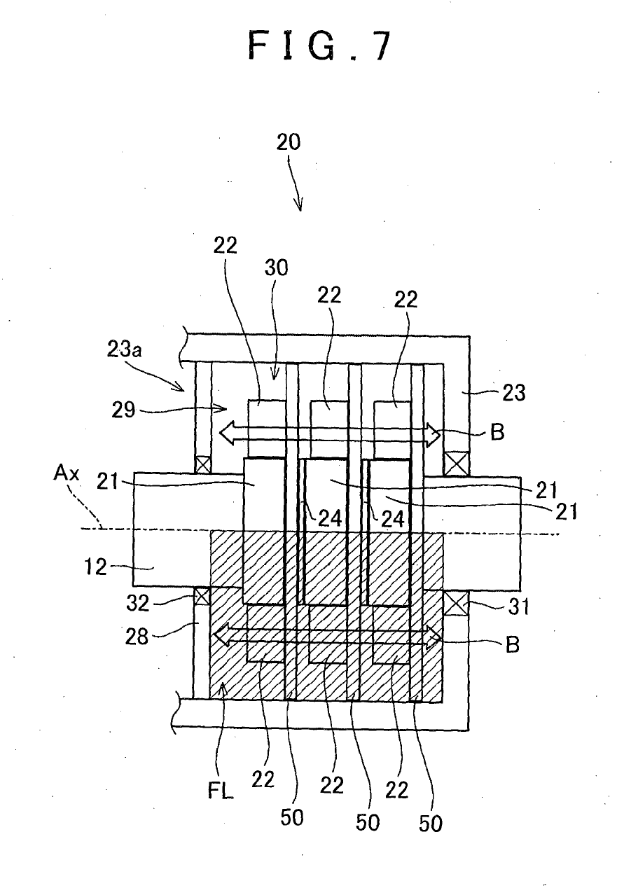

A description will hereinafter be made on the slip ring system according to a third embodiment of the present invention with reference to FIG. 6 and FIG. 7. FIG. 6 corresponds to FIG. 3 of the first embodiment, and it is a drawing in which a stationary plate of this embodiment is seen from the right in FIG. 7. FIG. 7 corresponds to FIG. 2 of the first embodiment. As it is apparent from these drawings, the shape of the stationary plate of this embodiment differs from the first embodiment, and the rest is the same as the first embodiment. Therefore, in this embodiment, components that are common with the first embodiment are designated by the same reference numerals, and their description is not repeated.

As shown in FIG. 6, a portion between the adjacent brushes 22 is eliminated from a stationary plate 50 of this embodiment. Accordingly, a communication hole 51 that penetrates in the direction of the axis Ax is provided in the stationary plate 50. As shown in this drawing, the communication hole 51 is provided to align with the brush 22 in the circumferential direction (the communication hole 51 is provided not to overlap with the brush 22 in the axial direction).

According to this embodiment, it is possible to generate the flow of the fluorinated liquid FL in the direction of the axis Ax, which is indicated by an arrow B in FIG. 7, in the housing room 29 as similar to the second embodiment. Accordingly, it is possible to increase the heat transfer coefficient between the fluorinated liquid FL and the combination of the slip ring 21 and the brush 22 and the heat transfer coefficient between the fluorinated liquid FL and the housing case 23. Therefore, it is possible to improve the cooling efficiencies of the slip ring 21 and the brush 22. In addition, the flow of the fluorinated liquid FL, which is indicated by the arrow B, can be generated around the brush 22 in this embodiment. Thus, it is possible to further improve the cooling efficiencies of the slip ring 21 and the brush 22. Therefore, wear of the brush 22 can be restricted because the slip ring 21 and the brush 22 can be restricted from generating heat as described above.

In addition, because the abrasive dusts can be removed from the space between the slip ring 21 and the brush 22 by generating the flow of the fluorinated liquid FL as described above, it is possible to restrict accumulation of the abrasive dusts in the space therebetween. Furthermore, it is possible in this embodiment to reduce the weight of the stationary plate 50.

The shape of the communication hole 51 is not limited to that shown in FIG. 6. For example, plural through holes that penetrate in the direction of the axis Ax may be provided in a portion where the communication hole 51 is provided in FIG. 6. Also, in this case, the flow of the fluorinated liquid FL, which is indicated by the arrow B in FIG. 7, can be generated.

The present invention is not limited to each of the above embodiments but can be implemented in various embodiments. For example, an apparatus in which the slip ring system of the present invention is installed is not limited to a hybrid motor. The slip ring system of the present invention may be installed in a variety of apparatuses that transfer electricity such as electric power or an electric signal between a rotating body and a stationary side.

The slip ring system, to which the present invention is applied, is not limited to a system in which a slip ring is provided on the rotating body and a brush is provided in the stationary side. The present invention may be applied to the slip ring system in which the brush is provided on the rotating body and the slip ring is provided in the stationary side.

The number of the slip rings in the slip ring system of the present invention is not limited to three. The number of the slip rings may be two or fewer or may be four or larger. In addition, the number of the brushes in the slip ring system of the present invention is not limited to three for each of the slip rings. Either the one or two brushes may be provided for each of the slip rings. Moreover, the four or more brushes may be provided for each of the slip rings.

1. A slip ring system comprising:
a ring member having conductivity, the ring member provided on one of a rotating body and a stationary unit, the rotating body rotating about an axis of the rotating body, and the stationary unit non-rotatably fixed;
a brush member having conductivity, the brush member provided on the other one of the rotating body and the stationary unit, the brush member configured to be pressed against the ring member, electricity transferred between the ring member and the brush member, a housing room provided in the stationary unit, the housing room housing the ring member and the brush member in the housing room, and a fluorinated liquid filled in the housing room.

2. The slip ring system according to claim 1, wherein
the fluorinated liquid is filled in the housing room such that a headspace is provided in the housing room.

3. The slip ring system according to claim 1, wherein
the fluorinated liquid is filled in the housing room such that a surface of the fluorinated liquid is positioned higher than a bottom end of the ring member and lower than a top end of the ring member when the rotating body stops.

4. The slip ring system according to claim 1, wherein
the plural brush members are provided in the slip ring system, and
the fluorinated liquid is filled in the housing room such that a contacting portion between at least one of the brush members and the ring member is soaked in the fluorinated liquid when the rotating body stops.

5. The slip ring system according to claim 1, wherein
the ring member is provided on the rotating body,
the three brush members are provided in the stationary unit,
the three brush members are disposed at 120° intervals on an outer periphery of the ring member in a circumferential direction such that any two of the brush members are positioned lower than the other brush member, and
the fluorinated liquid is filled in the housing room such that contacting portions between the ring member and the two brush members of the three brush members that are positioned lower than the other brush member are soaked in the fluorinated liquid when the rotating body stops.

6. The slip ring system according to claim 1, further comprising:
a case member fixed to the stationary unit, the housing room disposed in the case member;
a plate member to which either the ring member or the brush member, which is provided in the stationary unit, is attached, the plate member non-rotatably fixed to the case member, the plate member fixed to extend in a direction that intersects with the axis, and the plate member being provided with a communication hole that penetrates through the plate member in a direction that the axis extends.

7. The slip ring system according to claim 6, wherein
the brush member is attached to the plate member, and
the communication hole is provided in the plate member to align with the brush member in a circumferential direction.
